(19) United States
(12) Patent Application Publication
(10) Pub. No.: US 2009/0194480 A1
(43) Pub. Date: Aug. 6, 2009

(54) METHODS FOR ANALYZING AND REMOVING CONTAMINANTS IN LIQUID HYDROCARBON MEDIA

(76) Inventors: Cato R. McDaniel, The Woodlands, TX (US); Alan E. Goliaszewski, Hockessin, DE (US); David B. Engel, The Woodlands, TX (US); Roy Hernandez-Mena, The Woodlands, TX (US)

Correspondence Address: General Electric Company;GE Global Patent Operation, PO Box 861, 2 Corporate Drive, Suite 648, Shelton, CT, 06484, US

(21) Appl. No.: 12/026,648

(22) Filed: Feb. 6, 2008

(51) Int. Cl. B01D 17/02; G01N 1/00

(52) U.S. Cl. 210/643; 356/63

(57) ABSTRACT

A method for identifying contaminants within a liquid hydrocarbon media containing contaminants includes adding an optical tag to a water wash, adding the tagged water wash to the liquid hydrocarbon media, emulsifying the liquid hydrocarbon media and analyzing the contaminants in the hydrocarbon media with a microscope. Methods for removing contaminants and evaluating treatment are also provided.

### FIELD OF THE INVENTION

The invention relates to liquid hydrocarbon media and more particularly, to methods of determining and removing contaminants present in liquid hydrocarbon media.

### BACKGROUND OF THE INVENTION

Liquid hydrocarbon media, such as crude oil, contains a variety of contaminants, which can have detrimental effects on process equipment and in the operation of a refinery. These contaminants are broadly classified as salts, bottom sediment, water, solids and metals. The types and amounts of these contaminants vary depending on the particular hydrocarbon media.

Native water present in the liquid hydrocarbon media may contain various alkali salts, such as sodium, calcium, magnesium and potassium in the form of chloride, carbonate and sulfate salts. Upon thermal hydrolysis, chloride salts are the source of highly corrosive hydrochloric acid, which is severely damaging to refinery tower trays and other equipment. Carbonate and sulfate salts may be present in sufficient quantities to promote preheat exchanger scaling.

A standard treatment for removing small particles of solids and bottom sediment, salts, water and metals is a phase separation operation (commonly known as dewatering or desalting). A fresh water wash is injected into the hydrocarbon media. The hydrocarbon media and water are subjected to shear to thoroughly mix the fresh water and the hydrocarbon media to form an emulsion and to transfer the contaminants from the hydrocarbon media into the fresh water. The emulsion is resolved with the assistance of heat and residence time and the water is extracted.

Additives may be added to improve mixing of the oil and water phases, dehydrating the hydrocarbon media, providing faster water separation, improve salt or solids extraction and to generate oil-free effluent water. These additives, also known as demulsifiers or wetting agents, are usually fed to the hydrocarbon media to modify the oil/water interface. These additives allow droplets of water to coalesce more readily and for the surfaces of solids to be water-wetted. The additives reduce the effective time required for good separation of oil, solids and water.

However, contaminants may still reside in the hydrocarbon media if the treatment or additives selected for treatment are not appropriate for removing the contaminants or for the particular hydrocarbon media. Typically, the analysis of the types of contaminants in the hydrocarbon media may be measured by solubility techniques, deposition techniques, centrifugation, filtration, chromatography, combustion and spectroscopy. In a typical filtration or centrifuge process, the hydrocarbon media is mixed with a solvent, such as toluene, heated and filtered or centrifuged. The separated phase is measured to determine its contents and amounts. This procedure is labor-intensive and time-intensive. Other procedures may require a large amount of sample to measure and all of the procedures are indirect measurements of the hydrocarbon media.

What is needed is an improved process for effectively and quickly analyzing contaminants in a hydrocarbon media and for removing the contaminants from the hydrocarbon media.

### SUMMARY OF THE INVENTION

In one embodiment, a method for identifying contaminants within a liquid hydrocarbon media containing contaminants, said method comprising adding an optical tag to a water wash, adding the tagged water wash to the liquid hydrocarbon media, emulsifying the liquid hydrocarbon media and analyzing the contaminants in the hydrocarbon media with a microscope.

In another embodiment, a method for removing contaminants from liquid hydrocarbon media containing contaminants, said method comprising adding an optical tag to a water wash, adding the tagged water wash to the liquid hydrocarbon media to be treated, emulsifying the liquid hydrocarbon media, analyzing the contaminants in the hydrocarbon media with a microscope, selecting treatment for removing the contaminants and applying the treatment to the hydrocarbon media to remove the contaminants.

In another embodiment, a method for evaluating treatment for hydrocarbon media, said method comprising adding an optical tag to a water wash, adding the tagged water wash to liquid hydrocarbon media to be treated, emulsifying the hydrocarbon media, analyzing contaminants in the hydrocarbon media with a microscope, applying the treatment to be evaluated to the hydrocarbon media and analyzing the contaminants in the treated hydrocarbon media.

In another embodiment, an improved method for extracting water from a hydrocarbon media containing contaminants, said method comprising adding an optical tag to a water wash, adding the tagged water wash to the liquid hydrocarbon media, emulsifying the liquid hydrocarbon media, analyzing the contaminants in the hydrocarbon media with a microscope, selecting treatment for removing the contaminants, applying the treatment to the hydrocarbon media and removing the water wash.

The various embodiments provide improved methods for quickly characterizing contaminants in a liquid hydrocarbon media and for improved and efficient processes for removing the contaminants. The embodiments also provide methods for selecting treatment and operating conditions and indicating the effectiveness of different treatments and conditions.

### BRIEF DESCRIPTION OF THE DRAWINGS

FIG. 1 is a pictorial representation of a micrograph image of a crude oil sample with an optical tag.

FIG. 2 is a pictorial representation of a micrograph image of a crude oil sample with an optical tag.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Microscopic analysis provides an improved ability to visualize and characterize contaminants in liquid hydrocarbon media and to determine appropriate treatments. The analysis can be done quickly, directly and with very small amounts of sample. In one embodiment, a method for removing contaminants from liquid hydrocarbon media containing contaminants, said method comprising adding an optical tag to a water wash, adding the tagged water wash to the liquid hydrocarbon media to be treated, emulsifying the liquid hydrocarbon media, analyzing the contaminants in the hydrocarbon media with a microscope, selecting treatment for removing the contaminants and applying the treatment to the hydrocarbon media to remove the contaminants.

Liquid hydrocarbon media may be any type of crude oil, froth, oil-sands, extraction products and by-products from oil-sands, vacuum residua, solvent deasphated oils, gas oils, gasolines, diesel fuel, shale oil, liquefied coal, beneficiated tar sand, kerosene, petroleum systems, bitumen and mixtures and emulsions of the aforementioned.

The liquid hydrocarbon media may contain a variety of contaminants, including native water and solids, such as sand, silt, ash, dirt, clay, volcanic ash, drilling muds, rust, iron sulfide, metal, scale, gypsum and salts. The metals may be inorganic or organometallic compounds from hydrocarbon combinations with arsenic, vanadium, nickel, copper, iron and other metals. The salts may be alkali salts, such as sodium, calcium, magnesium and potassium in the form of chloride, carbonate and sulfate salts. The contaminants must be removed to prevent corrosion of process equipment, poisoning of catalyst beds and other detrimental effects during refining operations of a refinery. The amount of contaminants in the hydrocarbon media may be from about 1 ppm to about 500 ppm by weight based on the weight of the hydrocarbon media. In addition, the liquid hydrocarbon media may contain residual water, such as native or connate water. Water extraction processes, such as a desalting process, can also leave wash water behind in the hydrocarbon media. The amounts of residual water in the liquid hydrocarbon media can range from less than 1 percent by weight to over 50 percent by weight. Demulsified hydrocarbon media samples can have up to several percent by weight of residual water.

Optical tags are added to the hydrocarbon media to obtain characteristics of the hydrocarbon media and the contaminants within the hydrocarbon media. Optical tags may include dyes, pigments, nanoparticles, image enhancement agents or other optical reagents that are soluble in water and impart or enhance microscopic visibility or detectability of a contaminant residing in the hydrocarbon media. In one embodiment, the optical tags are organic dyes or inorganic dyes. In one embodiment, the organic dyes may be any type of water soluble organic dye. In another embodiment, the organic dyes include, but are not limited to, arylmethane dyes, cyanine dyes, safarine dyes, oxazin dyes and acridine dyes. In another embodiment, the inorganic dyes may be any type of water soluble inorganic dye. In one embodiment, the inorganic dye may be an inorganic salt dye, such as Prussian Blue or Tumbull's blue (ferric ferrocyanate) and India ink. When phase contrast microscopy is to be used, the optical tags may include material intended to alter the optical index of refraction of the underlying sample.

The optical tags are added to a water wash. In one embodiment, the water for the wash water is distilled water. In another embodiment, the optical tag is added to a water wash in a sufficient quantity to tag or tint the water wash. In one embodiment, the optical tag is added in an amount of from about 1 percent by volume to about 20 percent by volume, based on the volume of water. In another embodiment, the optical tag is added in an amount of from about 1 to about 10 percent by volume, based on the volume of water.

The water wash with the optical tag is added to the liquid hydrocarbon media to form an emulsion. This procedure may be carried out on a small sample, such as a deciliter of the hydrocarbon media. In one embodiment, the water wash is added in an amount suitable for forming an emulsion with the hydrocarbon media. In another embodiment, the water wash is added in an amount of from about 1 to about 50 percent by volume based on the volume of the emulsion. In another embodiment, the wash water is added in an amount of from about 1 to about 25 percent by volume based on the volume of the emulsion. In another embodiment, the wash water is added in an amount of from about 1 to about 10 percent by volume based on the volume of the emulsion. In one embodiment, the amount of liquid hydrocarbon media is present in an amount of from about 50 to about 99 percent by volume based on the volume of the emulsion. In another embodiment, the liquid hydrocarbon media is present in an amount of from about 75 to about 99 percent by volume based on the volume of the emulsion. In another embodiment, the liquid hydrocarbon media is present in an amount of from about 90 to about 99 percent by volume based on the volume of the emulsion.

The water wash and hydrocarbon media are emulsified by any conventional manner. In one embodiment, the water wash and hydrocarbon media are heated and thoroughly mixed to produce an oil-in-water emulsion. In one embodiment, the water wash and hydrocarbon media are heated at a temperature in a range of from about 90° C. to about 150° C. The water wash and hydrocarbon media are mixed in any conventional manner, such as an in-line static mixer or an in-line mix valve with a pressure drop of about 0.2 to about 2 bar depending on the density of the hydrocarbon media. A sample for microscopic analysis may be taken of the emulsion or the emulsion may be resolved and the wash water removed before a sample of the hydrocarbon media is taken for microscopic analysis.

The contaminants within the emulsion or separated hydrocarbon media are analyzed microscopically and the effect or incorporation of the optical tag is observed. The optical tag aids in characterizing the water droplets and solid particles and the interface of the water droplets and solid particles with the hydrocarbon media. In one embodiment, a method for identifying contaminants within a liquid hydrocarbon media containing contaminants, said method comprising adding an optical tag to a water wash, adding the tagged water wash to the liquid hydrocarbon media, emulsifying the liquid hydrocarbon media and analyzing the contaminants in the hydrocarbon media with a microscope.

The microscope may be any type of conventional microscope that magnifies an object that is too small to be seen with the naked eye. Microscopes may be used for microscopically analyzing hydrocarbon media in its natural state without prior specimen preparation. Some types of microscopes that may be used for analyzing hydrocarbon media include, but are not limited to, optical, near infrared, video-enhanced, confocal and fluorescence microscopes. The microscopes may also have phase contrast and or dark field or other illumination capabilities. Phase contrast provides the ability to enhance visualization of small components that differ in index of refraction without having perceptible spectral absorption or color differences.

A camera may be affixed to the microscope for taking micrograph images of the hydrocarbon media. Cameras may include video cameras, digital cameras and near infrared cameras. The micrograph images, including videograph images, may be recorded, digitized and analyzed directly or with the aid of a computer using standard image analysis software.

No special specimen preparation of the hydrocarbon media is needed. In one embodiment, samples of the hydrocarbon media are obtained by placing a small amount of the hydrocarbon medium in a micro-chamber or on a microscope slide, which may be sealed with a glass cover.

Microscopic analysis provides direct and real-time observation of liquid hydrocarbon media and particles and droplets dispersed within the hydrocarbon media. The hydrocarbon media is analyzed to identify the types, sizes, shapes and amounts of the particles and oil and water droplets found within the hydrocarbon media. The particles and droplets in the hydrocarbon media may be observed visually or may be mapped, including 3-D mapping. In another embodiment, particle size distributions and droplet size distributions may be obtained, amounts of particles and droplets may be measured, sphericity or roundness of the droplets may be determined and pH values may also be obtained. Videography allows continuous monitoring of hydrocarbon media to capture real-time emulsion dynamics for analysis of the emulsion properties of the hydrocarbon media.

From the analysis, the characteristics of the hydrocarbon media and contaminants within the hydrocarbon system can be determined and types of treatment suitable for removing the contaminants within the hydrocarbon media can be selected. Contaminants in the hydrocarbon media may be characterized by type of particle, particle size, amount of particle type, type of droplet, sphericity of the droplets and droplet amounts. Particles may be solids and droplets may be water droplets or oil droplets. The tagged wash water is visible in the emulsion helps to identify areas that have been contacted by the water wash and areas that were not contacted.

In one embodiment, a method for selecting treatment for removing water from liquid hydrocarbon media containing water, said method comprising analyzing water in the hydrocarbon media with a microscope and selecting treatment for removing the water.

Water in the hydrocarbon media may be characterized by type of droplet, sphericity of the droplets and droplet amounts. When a dyed wash water is employed as the tagged wash, then the presence of tinted water droplets indicates a droplet from the fresh water wash or a native water droplet that coalesced with the tinted fresh water. Tinted water droplets indicate water that is easily removed with water extraction.

Water droplets that are not tinted indicate native water droplets that could not coalesce with the tinted fresh water droplets. It is believed that these native water droplets have a rigid impermeable skin or interface formed by components from within the hydrocarbon media. The skin is either not porous or water permeable and will not allow the water droplet to coalesce with wash water droplets. The optical tag helps to identify the native water that cannot be removed by extraction with fresh water. Such refractory native water may be present in significant amounts and will require the use of additional treatment to overcome the encapsulating cover.

Water droplets that are not tinted, may be less round and appear to have a rigid or semi-rigid skin. These droplets have not been contacted by the water wash and will not easily be removed with a water extraction. It is believed that the rigid or semi-rigid skin on the water droplet is formed from salts or other solid or semi-solid materials including asphaltenes that contact the water droplets in the hydrocarbon media. Additional treatment is required to enhance removal. In one embodiment, different operation conditions may be selected, such as raising or lowering the temperature in the emulsion. In another embodiment, additives may be added to the emulsion. In one embodiment, the additives may be oxyalkylated organic compounds, anionic surfactants or mixtures of these materials. The oxyalkylated organic compounds include, but are not limited to, phenolformaldehyde resin ethoxylates, alkoxylated polyols and amines, such as Pluronic® block co-polymers. The anionic surfactants include alkyl or aryl sulfonates, such as dodecylbenzenesulfonate.

Water droplets that are not tinted and have a size of less than 10 micrometers are microemulsified water droplets that have not been contacted by the water wash and will not easily be removed with a water extraction. Often, the microemulsified water droplets have a rigid skin formed from contacting contaminants within the hydrocarbon media. Microemulsified water is very difficult to remove with a wash water extraction and requires additional treatment to enhance removal. In one embodiment, different operation conditions may be selected, such as raising or lowering the temperature in the emulsion. In another embodiment, additives may be added to the emulsion. In one embodiment, the additives may be oxyalkylated organic compounds, anionic surfactants or mixtures of these materials. The oxyalkylated organic compounds include, but are not limited to, phenolformaldehyde resin ethoxylates, alkoxylated polyols and amines, such as Pluronic® block co-polymers. The anionic surfactants include alkyl aryl sulfonates, such as dodecylbenzenesulfonate, and geminal surfactants, such as acetylenic alcohols.

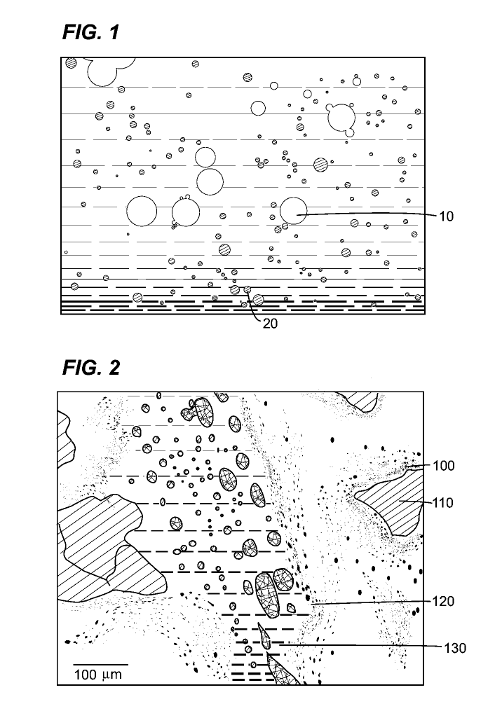

FIG. 1 is a pictorial representation of a micrograph image of optical tags being used in a crude oil sample. 10 mL of a Prussian Blue dye was added to 100 ml of distilled water to provide a highly colored solution. 5 ml of the colored solution was added to 95 ml of crude oil and mixed to form an emulsion. An aliquot of the emulsion sample was deposited over a glass slide and a micrograph image was obtained from a Zeiss Photomicroscope. The distilled water droplets are observed having a blue tint 10. The native water is shown without having a blue tint 20. This indicates that the native water is not coalescing with the fresh water and normal water extraction procedures will not be effective in removing the native water.

In one embodiment, a method for selecting treatment for removing solids from liquid hydrocarbon media containing solid contaminants, said method comprising analyzing the solids in the hydrocarbon media with a microscope and selecting treatment for removing the solids.

Solid particles within the hydrocarbon system are analyzed microscopically to identify the types, sizes and shapes of the particles. The particles may be observed visually or mapped, including 3-D mapping, particle size distributions may be obtained and the amounts of particles may be measured.

The tagged wash water helps to identify contaminant solids in the hydrocarbon media. Particles in the wash water indicate solids that are not soluble in the wash water. Larger particles may be sand grains, which can easily be removed with water extraction.

Very fine particles imbedded within the hydrocarbon media and not present in the tinted wash water may be clays. These clays and other fine particles imbedded in the hydrocarbon media are difficult to remove and require an additive to enhance removal. Examples of suitable additives for treatment that may be used to enhance removal are wetting agents, such as anionic surfactants and oxyalkylated surfactants. In one embodiment, an alkyl sulphate salt is sodium dodecylbenzenesulphate. The oxyalkylated organic compounds include, but are not limited to, phenolformaldehyde resin ethoxylates, alkoxylated polyols and amines, such as Pluronic® block co-polymers. The anionic surfactants include alkyl or aryl sulfonates, such as dodecylbenzenesulfonate.

Some particles may have developed a dual polarity from contacting other contaminants in the hydrocarbon medium. These particles can be covered by both tinted wash water and bitumen from the hydrocarbon medium. It can be difficult to remove these particles and additional treatment must be used. Examples of suitable additives for treatment that may be used to enhance removal are wetting agents, such as anionic surfactants and oxyalkylated surfactants. In one embodiment, an alkyl sulphate salt is sodium dodecylbenzenesulphate. The oxyalkylated organic compounds include, but are not limited to, phenolformaldehyde resin ethoxylates, alkoxylated polyols and amines, such as Pluronic® block co-polymers. The anionic surfactants include alkyl or aryl sulfonates, such as dodecylbenzenesulfonate.

Fine solids may accumulate at the interface between native water and the hydrocarbon media. Water droplets that are not tinted and that have a fine film around the droplet may indicate the presence of these fine solids. These solids are difficult to remove without an additive to enhance removal. Examples of suitable additives for treatment that may be used to enhance removal are wetting agents, such as anionic surfactants and oxyalkylated surfactants. In one embodiment, an alkyl sulphate salt is sodium dodecylbenzenesulphate. The oxyalkylated organic compounds include, but are not limited to, phenolformaldehyde resin ethoxylates, alkoxylated polyols and amines, such as Pluronic® block co-polymers. The anionic surfactants include alkyl or aryl sulfonates, such as dodecylbenzenesulfonate.

Fine solids may also accumulate around hydrocarbon media forming oil droplets, which will not be tinted. These solids are difficult to remove and require an additive to enhance removal. Examples of suitable additives for treatment that may be used to enhance removal are wetting agents, such as anionic surfactants and oxyalkylated surfactants. In one embodiment, an alkyl sulphate salt is sodium dodecylbenzenesulphate. The oxyalkylated organic compounds include, but are not limited to, phenolformaldehyde resin ethoxylates, alkoxylated polyols and amines, such as Pluronic® block co-polymers. The anionic surfactants include alkyl or aryl sulfonates, such as dodecylbenzenesulfonate.

FIG. 2 is a pictorial representation of a micrograph image of a crude oil sample with an optical tag. 10 mL of a Prussian Blue dye was added to 100 ml of distilled water to provide a highly colored solution. 5 ml of the colored solution was added to 95 ml of crude oil and mixed to form an emulsion. An aliquot of the emulsion sample was deposited over a glass slide and a micrograph image was obtained from a Zeiss Photomicroscope. There are crude oil pools surrounding large solid grains. These pools show very fine solids 100 imbedded within the crude oil with no dyed water present. These are believed to be clays. Some of the large sand grains 110 appear to have a dual polarity, since they are covered by bitumen and dyed water. The interfaces between water and crude oil often accumulate fine solids 120. These solids 120 are mainly located at the oil side of the interface. The presence of crude oil droplets with fine solids 130 within the crude oil is also observed.

Treatment may require adjusting the operating conditions or the use of additives or demulsifiers that are added to the hydrocarbon media. Adjusting the operating conditions may include elevating or lowering the emulsion temperature. Demulsifiers and additives are used to aid in separating the contaminants from the hydrocarbon media and in breaking down the surfaces of some of the contaminants, including surfaces of the water droplets. These additives may be added in amounts to contact the water from about 1 to about 1000 ppm by weight based on the weight of the hydrocarbon media. Combinations of additives may be used, but the total amounts of additives added should be in the range of from about 1 to about 1000 ppm by weight based on the weight of the hydrocarbon media.

Micrograph image analysis may also be used to determine treatment effectiveness for hydrocarbon media. Micrograph images are obtained post-treatment or during treatment to analyze and observe how the treatment of the hydrocarbon media is progressing. Based on the analysis, additional treatment may be applied and additional micrograph images may be obtained for further analysis of the sample. In one embodiment, a method for determining the effectiveness of a treatment for removing water from a hydrocarbon media containing water, said method comprising analyzing water in the hydrocarbon media with a microscope to obtain an initial analysis, treating the hydrocarbon media with a treatment to be evaluated and analyzing the water in the treated hydrocarbon media with a microscope.

In another embodiment, a method for evaluating treatment for hydrocarbon media, said method comprising adding an optical tag to a water wash, adding the tagged water wash to liquid hydrocarbon media to be treated, emulsifying the hydrocarbon media, analyzing contaminants in the hydrocarbon media with a microscope, applying the treatment to be evaluated to the hydrocarbon media and analyzing the contaminants in the treated hydrocarbon media.

In another embodiment, an improved method for extracting water from a hydrocarbon media containing contaminants, said method comprising adding an optical tag to a water wash, adding the tagged water wash to the liquid hydrocarbon media, emulsifying the liquid hydrocarbon media, analyzing the contaminants in the hydrocarbon media with a microscope, selecting treatment for removing the contaminants, applying the treatment to the hydrocarbon media and removing the water wash.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for identifying contaminants within a liquid hydrocarbon media containing contaminants, said method comprising adding an optical tag to a water wash, adding the tagged water wash to the liquid hydrocarbon media, emulsifying the liquid hydrocarbon media and analyzing untinted water droplets in the hydrocarbon media with a microscope.

2. The method of claim 1 wherein the hydrocarbon media is selected from the group consisting of crude oil, froth, oil-sands, vacuum residua, solvent deasphalted oils, gas oils, gasolines, diesel fuel, shale oil, liquefied coal, beneficiated tar sand, kerosene, petroleum systems, bitumen and mixtures and emulsions of the aforementioned.

3. The method of claim 1 wherein the hydrocarbon media is crude oil.

4. The method of claim 1 wherein the contaminants comprise water.

5. The method of claim 1 wherein the step of analyzing the untinted water droplets comprises measuring the sphericity of the untinted water droplets.

6. The method of claim 1 wherein the step of analyzing the untinted water droplets comprises obtaining a water droplet size distribution of the untinted water droplets.

7. The method of claim 1 wherein the step of analyzing the untinted water droplets comprises measuring sizes of the untinted water droplets.

8. The method of claim 1, wherein the optical tag comprises dyes, pigments, nanoparticles, image enhancement agents or other optical reagents soluble in water.

9. The method of claim 8 wherein the dye is an organic dye or an inorganic dye.

10. The method of claim 9 wherein the inorganic dye is Prussian Blue, India ink or Tumbull's Blue.

11. The method of claim 9 wherein the organic dye comprises a dye selected from the group consisting of arylmethane dyes, cyanine dyes, safarine dyes, oxazin dyes and acridine dyes.

12. The method of claim 1 wherein the contaminants comprise solid particles.

13. The method of claim 12 further comprising a step of analyzing the solid particles by obtaining a particle size distribution.

14. The method of claim 12 further comprising a step of analyzing the solid particles by measuring the size of the particles.

15. The method of claim 1 wherein the step of analyzing the untinted water droplets is performed to analyze residual contaminants after removal of the emulsion water wash.

16. A method for removing contaminants from liquid hydrocarbon media containing contaminants, said method comprising adding an optical tag to a water wash, adding the tagged water wash to the liquid hydrocarbon media to be treated, emulsifying the liquid hydrocarbon media, analyzing untinted water droplets in the hydrocarbon media with a microscope, selecting treatment for removing the contaminants and applying the treatment to the hydrocarbon media to remove the contaminants.

17. The method of claim 16 wherein the hydrocarbon media is selected from the group consisting of crude oil, froth, oil-sands, vacuum residua, solvent deasphalted oils, gas oils, gasolines, diesel fuel, shale oil, liquefied coal, beneficiated tar sand, kerosene, petroleum systems, bitumen and mixtures and emulsions of the aforementioned.

18. The method of claim 17 wherein the hydrocarbon media is crude oil.

19. The method of claim 16 wherein the contaminants comprise water.

20. The method of claim 16 wherein the step of analyzing the untinted water droplets comprises measuring the sphericity of the untinted water droplets.

21. The method of claim 16 wherein the step of analyzing the untinted water droplets comprises obtaining a water droplet size distribution.

22. The method of claim 16 wherein the step of analyzing the untinted water droplets comprises measuring the size of the untinted water droplets.

23. The method of claim 16, wherein the optical tag comprises dyes, pigments, nanoparticles, image enhancement agents or other optical reagents soluble in water.

24. The method of claim 23 wherein the dye is an organic dye or an inorganic dye.

25. The method of claim 24 wherein the inorganic dye is Prussian Blue, India ink or Tumbull's Blue.

26. The method of claim 24 wherein the organic dye comprises a dye selected from the group consisting of arylmethane dyes, cyanine dyes, safarine dyes, oxazin dyes and acridine dyes.

27. The method of claim 16 wherein the contaminants comprise solids.

28. The method of claim 27 further comprising a step of analyzing the solid particles by obtaining a particle size distribution.

29. The method of claim 27 further comprising a step of analyzing the solid particles by measuring the size of the particles.

30. The method of claim 16 wherein treatment is selected from the group consisting of water extraction, adjusting operating conditions, addition of additives and combinations of the foregoing.

31. (canceled)

32. The method of claim 30 wherein the treatment comprises the addition of additives and said additives comprise oxyalkylated organic compounds, anionic surfactants or mixtures of these materials.

33. The method of claim 32 wherein the oxyalkylated organic compounds comprise phenolformaldehyde resin ethoxylates, alkoxylated polyols or amines.

34. The method of claim 32 wherein the anionic surfactants comprise alkyl aryl sulfonates or geminal surfactants.

35. The method of claim 16 wherein the step of analyzing the untinted water droplets is performed to analyze residual contaminants after removal of the emulsion water wash.

36. A method for evaluating treatment for hydrocarbon media, said method comprising adding an optical tag to a water wash, adding the tagged water wash to liquid hydrocarbon media to be treated, emulsifying the hydrocarbon media, analyzing untinted water droplets in the hydrocarbon media with a microscope, applying the treatment to be evaluated to the hydrocarbon media and analyzing contaminants in the treated hydrocarbon media.

37. An improved method for extracting water from a hydrocarbon media containing contaminants, said method comprising adding an optical tag to a water wash, adding the tagged water wash to the liquid hydrocarbon media, emulsifying the liquid hydrocarbon media, analyzing the untinted water droplets in the hydrocarbon media with a microscope, selecting treatment for removing contaminants, applying the treatment to the hydrocarbon media and removing the water wash.
